(19) United States
(12) Patent Application Publication
(10) Pub. No.: US 2018/0313048 A1
(43) Pub. Date: Nov. 1, 2018

(54) CONNECTOR FOR SECURING A SNOW PLOW BLADE TO A SUPPORTING STRUCTURE SUCH AS A MOLDBOARD

(71) Applicants: Daren Lynch, Oneida, NY (US); Nathan Couper, West Henrietta, NY (US)

(72) Inventors: Daren Lynch, Oneida, NY (US); Nathan Couper, West Henrietta, NY (US)

(21) Appl. No.: 15/497,898

(22) Filed: Apr. 26, 2017

(51) Int. Cl. E01H 5/06; F16B 39/12; F16B 21/12

(52) U.S. Cl. CPC E01H 5/065; F16B 21/12; F16B 39/12; E01H 5/061

(57) ABSTRACT

A connector for securing a snow plow blade to a supporting structure such as a moldboard, especially a connector that can quickly connect and disconnect the blade to the support structure.

### FIELD OF THE INVENTION

The present invention relates to a connector for securing a snow plow blade to a supporting structure such as a moldboard, especially a connector that can quickly connect and disconnect the blade to the support structure.

### BACKGROUND OF THE INVENTION

Snow plows generally push snow, ice, slush, and other frozen forms of water away from the path of a moving vehicle. A conventional snow plow system includes a generally semi-cylindrical, concave moldboard, a vehicle, and a frame attaching the moldboard to the vehicle. Typically moldboards are positioned in front of the vehicle; however, moldboards may also be positioned beneath the vehicle, behind the vehicle, or to the side of the vehicle. A moldboard is generally designed to move as much frozen water from the supporting terrain surface as reasonably possible. Such terrain surfaces include, for example, paved roadways, gravel roads, and airport runways. Consequently, the lower portion of the moldboard encounters relatively the most volume of frozen water, especially forms that are most compacted and hardened. Also, the lower portion of the moldboard will forcefully contact loose debris, such as gravel, as well as fixed objects, such as manhole covers, and in addition will tend to engage in forceful contact with the supporting terrain surface.

Because the lower portion of the moldboard encounters the brunt of such forceful contacts with forms of frozen water, loose debris, fixed objects, and the supporting terrain surface, the lower portion of the moldboard becomes damaged and worn excessively, which may require the replacement of an entire moldboard. To overcome the problem of replacing an entire moldboard due to damage and wear of the lower portion of the moldboard, replaceable blades have been mounted to the front of the lower portion of the moldboard, and extend downwardly, beneath the moldboard. The blades typically are fashioned of an extremely hard material, such as steel. Thus, the blades, rather than the moldboard, absorb the forces encountered by movement of the moldboard through the frozen types of water, loose debris, and fixed objects and from engagement with the supporting terrain surface. Because the blades may be formed of a very hard material, they tend to be less subject to damage and wear than moldboards. Also, when blades become damaged or worn excessively, a relatively inexpensive blade may be replaced, instead of replacing the entire moldboard.

In some instances, blades have been welded to the lower edges of moldboards; however, a cutting torch must be used to remove a damaged or worn blade, and a new replacement blade must be welded back to the moldboard—a laborious and time-consuming procedure. In other instances, moldboards and blades have been designed with each possessing a series of apertures, extending laterally across the lower edge of the moldboard, and along the length of the blade, respectively, that are designed to overlap and be co-extensive so that a series of bolts may extend through the overlapping, co-extensive apertures, with the head portion of the bolt abutting the front face of the blade, and a nut threadably secured to the end of the bolt extending through the blade and the moldboard, with the tightened nut abutting the rear surface of the moldboard. Such bolts have been provided also with washers to help prevent loosening of the nut and to help absorb some of the forces encountered by the blade and transmitted through the bolt to the moldboard. A problem with utilizing bolts to secure the blade to the moldboard is that the bolts often become corroded and the nuts become difficult to rotate and to disattach. Sometimes a cutting torch or a hack saw must be used to cut the bolt in order for it to become disattached. Further, when it becomes difficult to remove a nut and the bolt, a workman must dispose himself behind and beneath the moldboard for prolonged durations in an awkward and unsafe position.

When a blade has been excessively damaged or worn, it is important to be able to disconnect the existing, damaged or worn blade quickly from the moldboard, and to replace it quickly with a new blade. Such a relatively quick disconnect and connect procedure will not only save labor costs and enhance safety, but also, will permit the snow plow to return to service quickly.

### SUMMARY OF THE INVENTION

The present invention relates to a connector for securing a snow plow blade to a supporting structure such as a moldboard, especially a connector that can quickly connect and disconnect the blade to the support structure.

### BRIEF DESCRIPTION OF THE DRAWINGS

The invention will be described with reference to the accompanying drawings, wherein:

FIG. 1 is a schematic side view of a connector in accordance with one embodiment of the present invention securing a snow plow blade to a moldboard;

FIG. 2 is a schematic plan view of the connector securing a snow plow blade to a moldboard, as shown in FIG. 1, with the snow plow blade and moldboard depicted with broken lines;

FIG. 3 is a cross-sectional illustration of the connector shown in FIGS. 1 and 2 securing a snow plow blade to a moldboard, taken along the line A-A shown in FIG. 2;

FIG. 4 is a schematic side view of a stud including an integral flange forming a portion of the connector shown in FIG. 1;

FIG. 5 is a schematic end view of the stud and integral flange shown in FIG. 4;

FIG. 6 is a schematic perspective view of the stud and integral flange shown in FIG. 4;

FIG. 7 is a perspective partial view illustrating the connector shown in FIG. 1 securing the snow plow blade to the moldboard;

FIG. 8 is an end view of a taper lock ring employed in the connector shown in FIG. 1;

FIG. 9 is a cross-sectional illustration of the taper lock ring shown in FIG. 8 taken along the line A-A;

FIG. 10 is a cross-sectional illustration of the taper lock ring shown in FIG. 8 taken along the line B-B;

FIG. 11 is a perspective view of the taper lock ring shown in FIG. 8;

FIG. 12 is a schematic plan view of the connector securing a snow plow blade to a moldboard, as a close-up view as shown in FIG. 2;

FIG. 13 is a schematic cross-sectional illustration of a connector in accordance with another embodiment of the present invention securing a snow plow blade to a moldboard;

FIG. 14 is a schematic end view of the connector shown in FIG. 3;

FIG. 15 is a schematic cross-sectional illustration of a connector in accordance with yet another embodiment of the present invention securing a snow plow blade to an adapter plate, which in turn is secured to a moldboard.

FIG. 16 is a schematic side view of the connector shown in FIG. 1 securing a snow plow blade to a moldboard, with a cap covering the taper lock ring in partial cross-section;

FIG. 17 is a partial view of the connector securing a snow plow blade to a moldboard as shown in FIG. 16 with more detail in the cross-sectional illustration of the cap mounted over the connector;

FIG. 18 is a schematic cross-sectional illustration of a connector in accordance with still another embodiment of the present invention securing a snow plow blade to an adapter plate, which in turn is secured to a moldboard; and

FIG. 19 is a partial plan illustration of an adapter plate that may be utilized with various embodiments of the present invention.

### DESCRIPTION OF A PREFERRED EMBODIMENT

The present invention will be described with reference to the accompanying drawings wherein like reference numerals refer to the same item. It should be appreciated that the following description is intended to be exemplary only and that the scope of the invention envisions other variations and modifications of these particular exemplary embodiments.

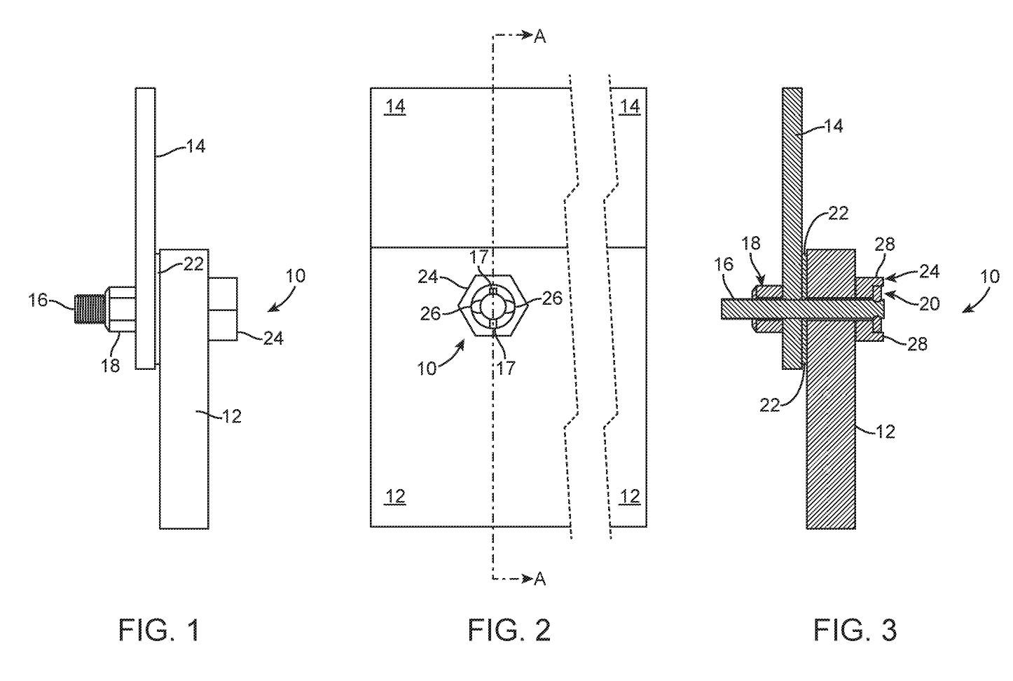

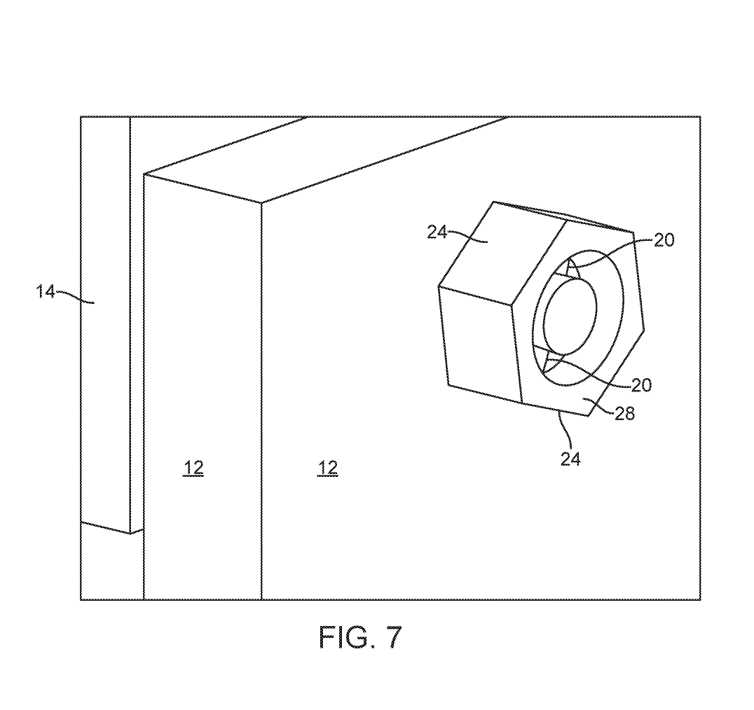

There shown in FIGS. 1-3 and 7 a connector 10 securing a snow plow blade 12 to a moldboard 14. The blade 12 depends from the lower edge of the moldboard 14 and possesses a length, a height, and a thickness. The blade 12 possesses a front face and a rear face. The length of the blade laterally extends along the lower edge of the moldboard and possesses a series of laterally spaced apertures (only one of which is shown in FIG. 1) extending through the thickness of the blade 12. The blade 12 may be segmented. Each aperture is defined by a wall, and preferably the wall bears a cylindrical configuration.

The moldboard 14 possesses a laterally extending lower edge and possesses a thickness along the lower edge. The moldboard 14 possesses a front surface and a rear surface and possesses a series of laterally spaced apertures (one of which is shown in FIG. 3) extending through the thickness of the lower edge thereof. Each of the apertures is defined by a wall, which preferably possesses a cylindrical configuration.

The apertures in the blade 12 are positioned so that they may overlap and be coextensive with associated ones of the apertures in the moldboard 14. Also preferably, the diameters of the walls of the apertures in the blade 12 are equal to the diameters of the walls of the apertures in the moldboard 14. It will be appreciated that the configurations of the walls of the apertures in the blade 12 and the apertures in the moldboard 14 may be other than cylindrical and still accommodate a connector in accordance with the present invention.

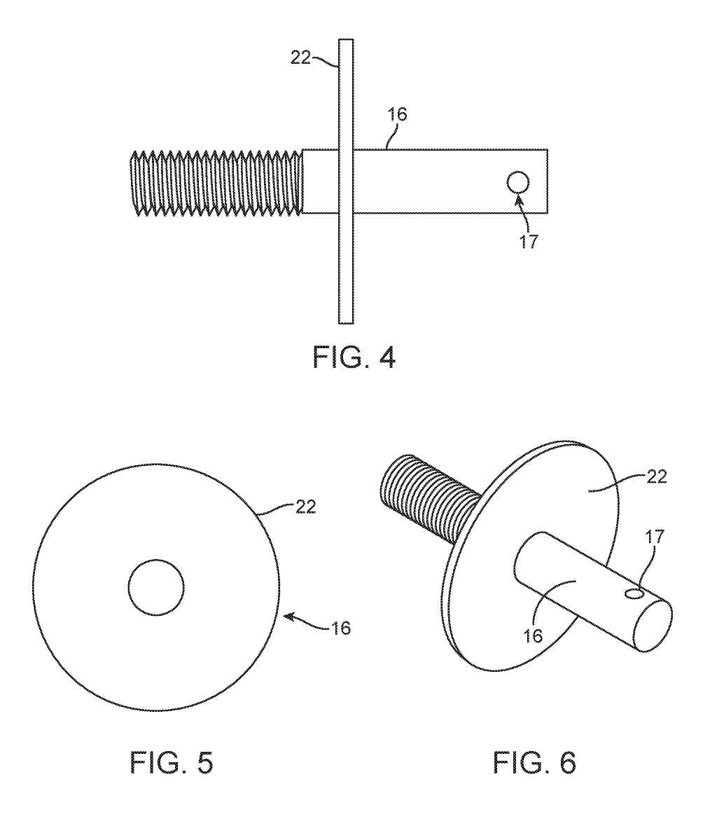

As shown in FIGS. 3-6, the connector 10 includes an elongate stud 16 possessing a longitudinal length and two opposing longitudinal ends. The first longitudinal end possesses a threaded periphery adapted to receive a nut 18 threadably thereon. The nut 18 is preferably a lock nut, such as a nut in which the threads have been coated with nylon or another plastic. Preferably the stud 16 possesses a generally cylindrical periphery preferably having a diameter essentially equal to the diameters of the overlapping, coextensive apertures in the blade 12 and the moldboard 14.

In an alternative embodiment, the apertures in the moldboard 14 may be tapped or threaded to threadably, selectively receive the threaded longitudinal end of the stud 16. In such an alternative embodiment, either the threaded longitudinal end of the stud 16 may extend past the threaded aperture in and past the rear surface of the moldboard 14 and may also be fitted with a nut 18 to provide an additional measure of selectively holding the stud 16 in a desired position relative to the moldboard 14, or, the threaded longitudinal end of the stud 16 may extend into and through the threaded aperture, but not past, the threaded aperture.

The second longitudinal end of the stud 16 possesses a hole 17 transversely, centrally extending therethrough and into which a locking pin 20 may be lodged and extend. The central portion of the locking pin 20 may be slightly bulbous so as to wedge against the wall of the hole. It should be appreciated that instead of a single pin 20, a pair of pins may be inserted into and lodged into the hole at diametrically opposite ends of the hole. The pin or pins may be inserted into the hole 17 with a hammer or other tool. Also, the invention contemplates that the pin 20, instead of extending through a transverse hole in the stud 16, may be integrally formed with the stud 16.

The stud 16 as shown in FIG. 1 includes a integrally formed flange 22 radially protruding therefrom and disposed between the blade 12 and the moldboard 14. Preferably the flange 22 possesses the configuration of a disc having two opposing planar, radially extending, parallel surfaces, with one of the surfaces abutting the rear face of the blade 12 and the other surface abutting the front surface of the moldboard 14. The flange 22 helps strengthen the connection of the blade 12 to the moldboard 14 by tending to reduce the wobbling of the blade 12 relative to the moldboard 14.

The connector 10 as shown in FIGS. 1-3 also includes a taper lock ring 24 that is mounted circumferentially around the stud 16. Preferably the taper lock ring 24 includes a hole centrally, longitudinally therethrough which possesses a diameter that is essentially equal to the diameter of the stud 16. The taper lock ring 24 includes an inner surface that is preferably planar and is adapted to conformingly abut the front face of the blade 12. An opposing outer surface of the taper lock ring 24 is tapered, inclined, or ramped in a helical direction and is adapted to compressively abut the locking pin 20. Preferably the degree of incline is in a range of about five degrees to twelve degrees and most preferably a taper equal to a thread pitch of 0.212 inches. Preferably, the opposing outer surface includes two ramps or inclines each disposed 180 degrees apart. As will be better appreciated from reading further, each end of the locking pin 20 protruding from a side of the stud 16 abuts against the initial portion of the associated one of the two ramps, and as the taper locking ring 24 is rotated relative to the locking pin 20, the ends of the locking pin 20 abut increasingly thick portions of the ramp, thereby creating increasing compressive abutment of the locking pin 20 with the taper locking ring 24.

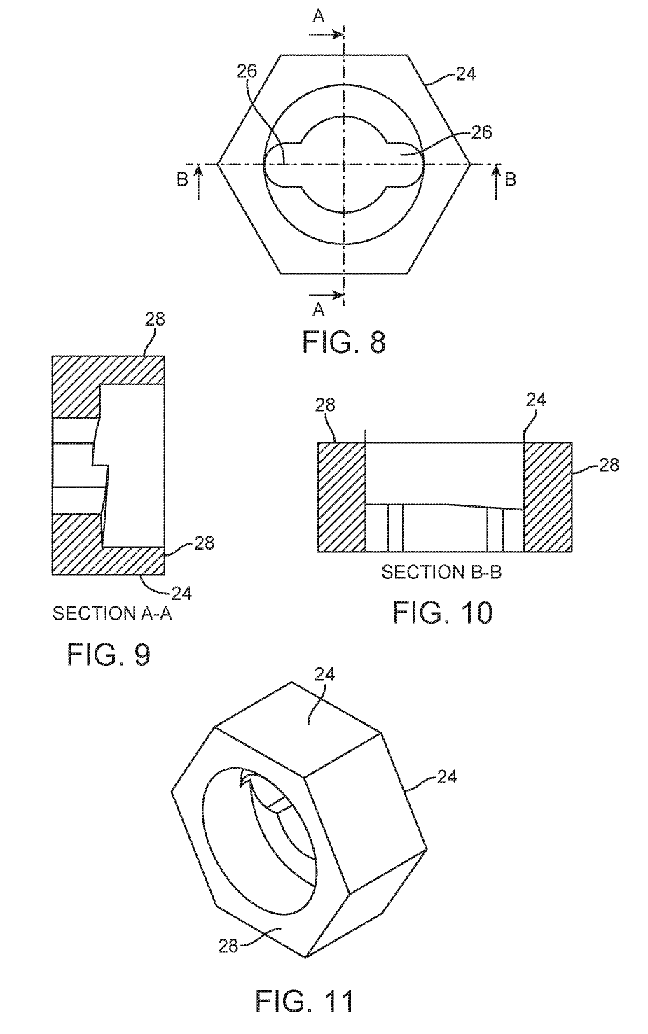

As best shown in FIGS. 2, 7, 8, 11, and 12, the taper lock ring 24 possesses a hexagonal, or alternatively, a square, peripheral profile to accommodate a wrench being applied to the periphery of the taper lock ring 24 to rotate the taper lock ring 24 relative to the stud 16 and relative to the locking pin 20. Also as best shown in FIGS. 2 and 8, the taper lock ring 24 is provided with a transversely extending slot 26 that extends completely longitudinally through the taper lock ring 24 from the inner surface to the outer surface. The slot 26 is configured and dimensioned so that the locking pin 20 may slide in and completely through the taper lock ring 24.

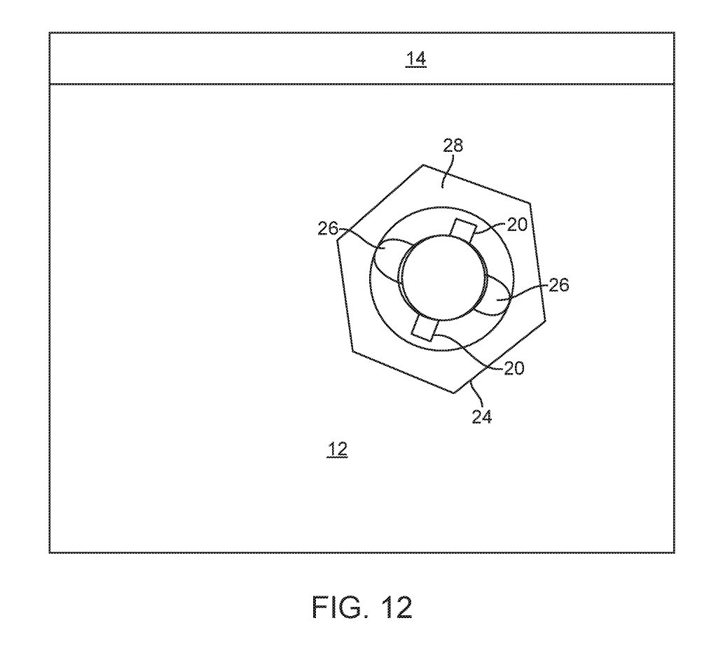

By rotating the taper lock ring 24 relative to the stud 16 and the locking pin 20 in one rotational direction, the locking pin 20 comes into contact with the helically inclined surface or surfaces. Further rotation of the taper lock ring 24 creates increasingly forceful contact between the helically inclined surface and the locking pin 20, which concomitantly causes the inner surface of the taper lock ring 24 to compressively abut against the front face of the blade 12, causes the rear face of the blade 12 to forcefully abut against the adjacent surface of the flange 22, causes of the other surface of the flange 22 to forcefully abut the front surface of the moldboard 14, and causes the nut 18 to forcefully abut against the rear surface of the moldboard 14. It will be appreciated that the taper lock ring 24 may be rotated up to approximately 170 degrees relative to the slot 26. For example, as shown in FIG. 12, the locking pin 20 is rotated at approximately 90 degrees relative to the slot 26 The forceful abutment of the locking pin 20 against the ramp on the outer surface of the taper ring lock 24 and the frictional engagement resulting therefrom inhibit unintended rotation of the taper ring lock 24 in an opposite rotational direction that would tend to lessen the force of the abutment.

In order to install the connector 10 to secure the blade 12 to the moldboard 14, the stud 16, the nut 18, and the locking pin 20 are positioned as shown in FIG. 1, but without the taper lock ring 24. Then, the taper lock ring 24 is orientated so that the slot 26 thereof aligns with the locking pin 20, and then the taper lock ring 24 is slid longitudinally inward, to the position shown in FIG. 1. Thereafter, a wrench may be used to rotate the taper lock ring 24 relative to the stud 16 and the locking pin 20 whereby the blade 16 may be compressively secured to the moldboard 14. In order to disattach the blade 12 from the moldboard 14, a wrench is used to rotate the taper lock ring 24 in the opposite rotational direction to a position where the slot 26 therein aligns with the locking pin 20 and then the taper lock ring 24 is pulled longitudinally outward. The locking pin 20 is then removed such as by hammering on one end thereof.

It should be appreciated that the connector 10 shown in FIGS. 1-3 may assume a reverse orientation from that shown in FIGS. 1-3. That is, the threaded end of the stud 16 and the nut 18 may be positioned longitudinally outward from the front face of the blade 12, and the taper lock ring 24 and the locking pin 20 may be positioned longitudinally rearward of the tear surface of the moldboard. Nevertheless, the orientation shown in FIGS. 1-3 is preferred because a workman need not go behind the moldboard 14 in order to disattach the blade 12 from the moldboard 14.

The invention also contemplates that a cap may be selectively secured over the longitudinal end of the stud 16 through which the locking pin 20 extends and preferably such as the cap covers at least a portion of the taper lock ring 24. The invention contemplates that the cap may be hollow, with an open end, and possesses an interior profile that corresponds with the peripheral profile of the taper lock ring 24, such as a hexagonal profile. The invention also contemplates that the interior surface of the cap may be coated with rubber or another elastic material so that the interior surface of the cap compressively engages the peripheral surface of the taper lock ring 24, thereby tending to inhibit the cap from being displaced from a position of covering the longitudinal end of the stud 16 through which the locking pin 20 extends and covering the locking pin 20 as well. It will be appreciated that the cap serves to prevent salt, water, and other corrosive materials from contaminating the stud 16, the locking pin 20, or the taper lock ring 24. The cap also serves to help prevent snow, ice, and other materials from tending to dislodge the pin 20 from extension into the transverse hole in the stud 16. As shown in FIGS. 3, 7, and 11, the taper lock ring 24 may also be provided with longitudinally outwardly protruding lip 28 that circumferentially surrounds the pin 20. The lip 28 also helps to protect against any materials acting on the locking pin 20 that would tend to dislodge the locking pin 20 from the transverse hole in the stud 16.

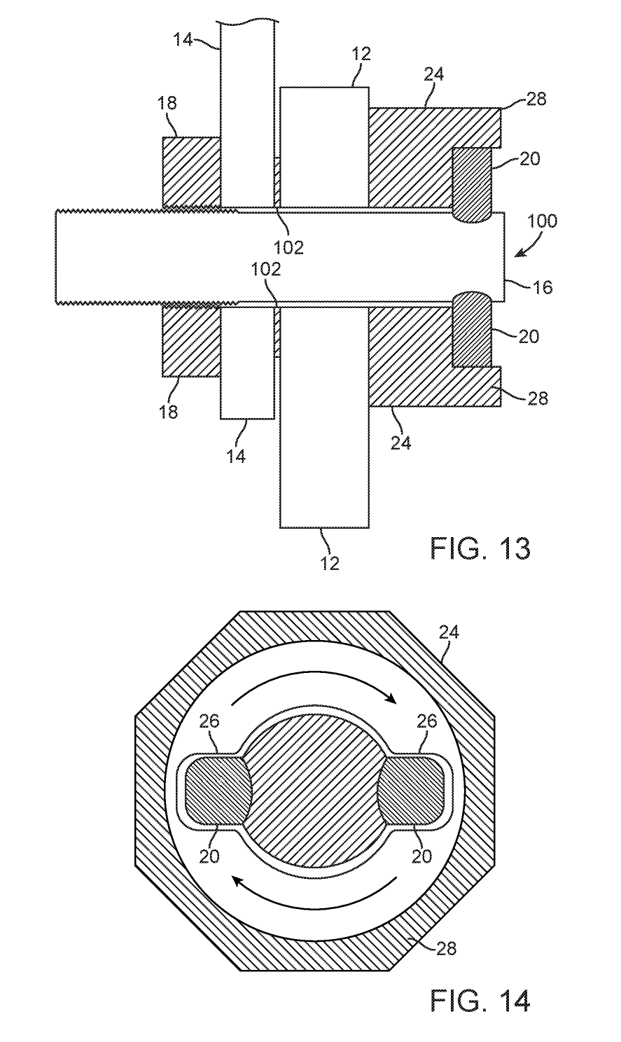

FIG. 13 shows a connector 100 in accordance with another embodiment of the present invention. The connector 100 is in all respects similar to the connector 10 shown in FIGS. 1-3, except that instead of a flange 22, a spacing ring 102 is disposed circumferentially about the stud 16, between the rear face of the blade 12 and the front surface of the moldboard 14. The spacing ring 102 may comprise, for example, a washer or a “C”-ring washer. The spacing ring 102 preferably completely circumferentially surrounds the stud 16. Also, preferably, as shown in FIG. 13, the stud 16 may be provided with a circumferential groove adapted to receive the spacing ring 102. The inner peripheral profile of the spacing ring 102 is preferably slightly smaller than the circumferential periphery of the stud 16 such that the spacing ring 102 tends to snap into the circumferential depression in the stud 16.

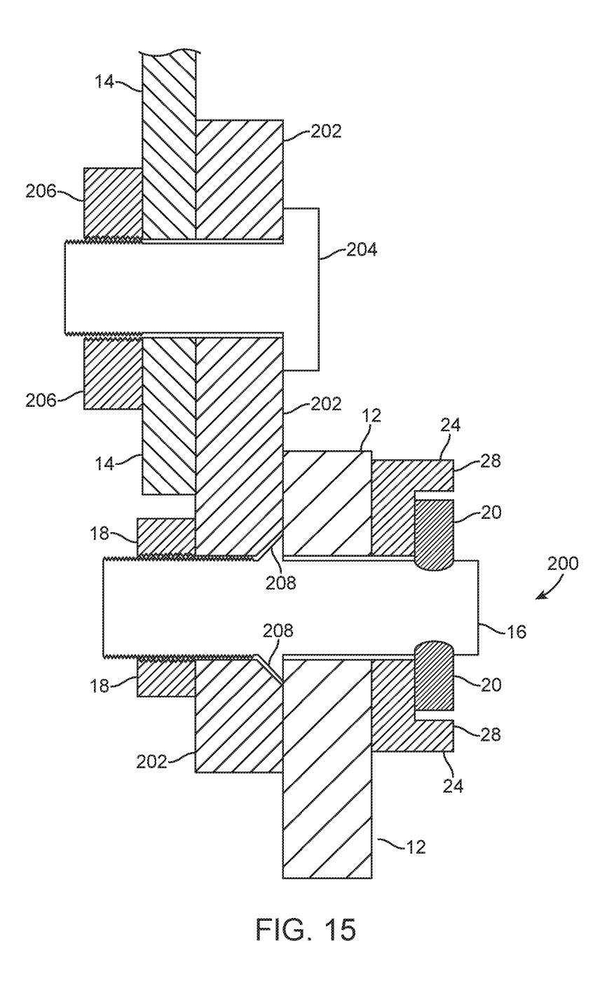

FIG. 15 shows a connector 200 in accordance with yet another embodiment of the present invention. Instead of the connector 200 connecting the blade 12 directly to the moldboard 14, the connector 200 connects the blade 12 to an adapter plate 202 which is disposed along and connected to the lower edge of the moldboard 14. The adapter plate 202 possesses a thickness and possesses a forward surface and a rearward surface. The adapter plate 202 possesses a series of laterally spaced upper apertures (one of which is shown) extending through the thickness of the adapter plate 202 and a series of laterally spaced lower apertures (one of which is shown) extending through the thickness of the adapter plate 202. Each of the upper apertures and each of the lower apertures is defined by an associated wall. The apertures in the series of upper apertures in the adapter plate 202 are positioned so as to overlap and be coextensive with the associated ones of the apertures in the series of apertures in the moldboard 14. Likewise, the apertures in the series of apertures in the blade 12 are positioned so as to overlap and be coextensive with associated ones of the apertures in the series of the lower apertures in the adapter plate 202. The foregoing apertures as shown in FIG. 15 each preferably possess a cylindrical configuration, and preferably each set of overlapping, coextensive apertures possess identical diameters.

As shown in FIG. 15, the adapter plate 202 may be connected to the moldboard 14 in a conventional matter by means of a bolt 204 extending through each set of overlapping, coextensive apertures in the adapter plate 202 and the moldboard 14. The bolt 204 includes a head portion positioned and adapted so as to abut the forward surface of the adapter plate 202 and includes threaded distal end adapted to extend behind the rear surface of the moldboard 14 and adapted to receive a nut 206 threadably thereon.

The connector 200 as shown in FIG. 15 is in all respects similar to the connector 10 shown in FIGS. 1-3, however the shape and position of the flange is different. As shown in FIG. 15, each of the apertures in the series of the lower apertures in the adapter plate 202 is provided with a depression or mouth in the forward surface of the adapter plate 202. The depression preferably possesses a conical shape, but may also possess other shapes, such as a cross shape or a hexagonal shape or a combination of cross shaped and conical or hexagonal and conical, for example. The flange 208 in the connector 200 shown in FIG. 15 possesses a configuration corresponding to the configuration of the depression, which again, is preferably conical. Also preferably, the surface of the flange 208 facing the rear face of the blade 12 is planar and adapted to be disposed in a co-planar relationship with the forward surface of the adapter plate 202 when the connector 200 is in a position of securing the blade 12 to the adapter plate 202. Alternatively, the face of the flange may be slightly indented and recessed from the forward surface of the adapter plate 202.

As with the embodiment shown in FIG. 1, the embodiment shown in FIG. 15 may also include alternative embodiments where the apertures in the adapter plate 202 are tapped or threaded to threadably receive the threaded longitudinal end of the stud 16. Likewise, in this alternative embodiment, either the threaded longitudinal end of the stud 16 may extend past the threaded aperture in and past the rearward surface of the adapter plate 202 and may also be fitted with a nut 18 to provide an additional measure of selectively holding the stud 16 in a desired position relative to the adapter plate 202, or, the threaded longitudinal end of the stud 16 may extend into and through, but not past, the threaded aperture.

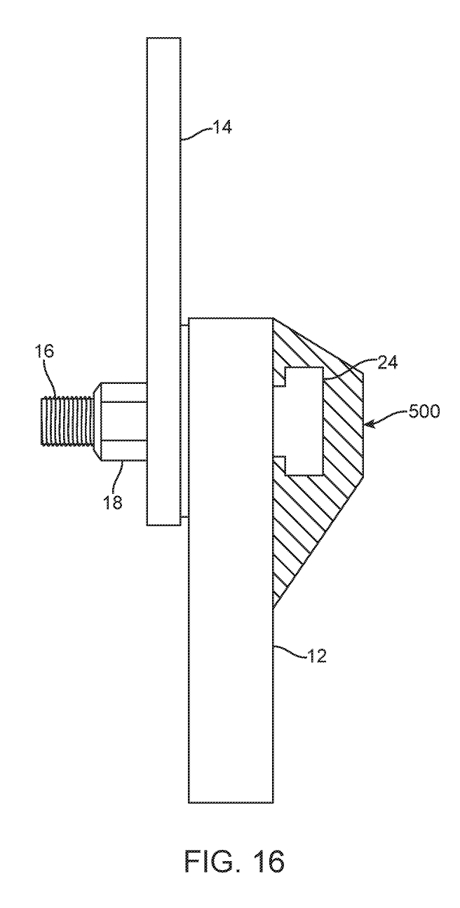

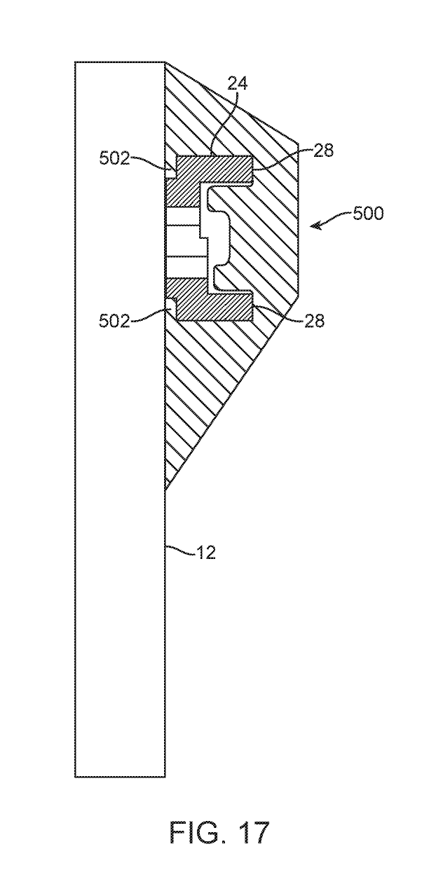

There shown in FIGS. 16 and 17 a cap 500 that may be employed with various embodiments of the connector in accordance with the present invention. The cap 500 is preferably fashioned of rubber or other elastomeric material, or of a substantially rigid, but slightly flexible, plastic. The cap 500, in accordance with a preferred embodiment, generally possesses a planar surface adapted to conformingly abut the front face of the blade 12 in the vicinity of the connector, especially in the vicinity of the taper lock ring 24. The cap 500 preferably includes a cavity opening to the planar surface thereof which is adapted to receive, and preferably to conformingly receive, the periphery of the taper lock ring 24 when the taper lock ring 24 assumes a rotational position relative to the stud 16 and the locking pin 20 to achieve maximum desired compressive force between the locking pin 20 and the helical ramp or ramps in the outer surface of the taper lock ring 24.

Preferably the peripheral surface of the cap 500 opposite to the planar surface is generally bulbous. Also preferably, the lower portion of the bulbous surface of the cap 500 positioned generally beneath the taper lock ring 24 when the cap 500 is mounted over the taper lock ring 24 possesses a relatively gentle or low-grade slope so that snow and other forms of frozen water may relatively easily glide upward from the lower portion of the front face of the blade 12 and up and around the cap 500, without tending to dislodge the cap 500 from a position covering the taper lock ring 24.

Although the cavity in the cap 500 may be configured so as to cause the walls of the cavity to squeeze and compress against the outer periphery of the taper lock ring 24, the invention contemplates that preferably the periphery of the inner surface of the taper lock ring 24 is indented, as best shown in FIG. 17, and that the cap 500 is provided with a lip 502 configured to conformingly depend into the indented periphery of the taper lock ring 24. It will be appreciated that the indented periphery of the taper lock ring 24 may be continuous and completely encompass the taper lock ring 24, or may be fashioned in one or more segments. In the event that the indented periphery is fashioned in one or more segments, the cap 500 would be provided with a lip that includes one or more ears configured to depend into an associated one of the segmented indentations. It will be appreciated that the cap 500 and the indentations in the taper lock ring 24 are fashioned of material and configured such that the lip or ears tend to snap into associated indentations.

The cap 500 may possess planar side or lateral surfaces that are preferably co-parallel so as to minimize interference of the cap 500 with snow or other form of frozen water rising upwardly from the lower portion of the blade 12 as the blade is moved through the snow or other form of frozen water.

The cap 500 also preferably includes a cavity wall configured to protrude into the taper lock ring 24 in the region surrounding the locking pin 20, as best shown in FIG. 17. The protruding cavity wall may be configured so as to abut, and preferably compressively abut, the interior periphery of the protruding lip 28 of the taper lock ring 24. As such the lip 28 of the taper lock ring 24 is squeezed between portions of the cap 500. Further, the protruding cavity wall may be configured so as to conformingly engage the locking pin 20.

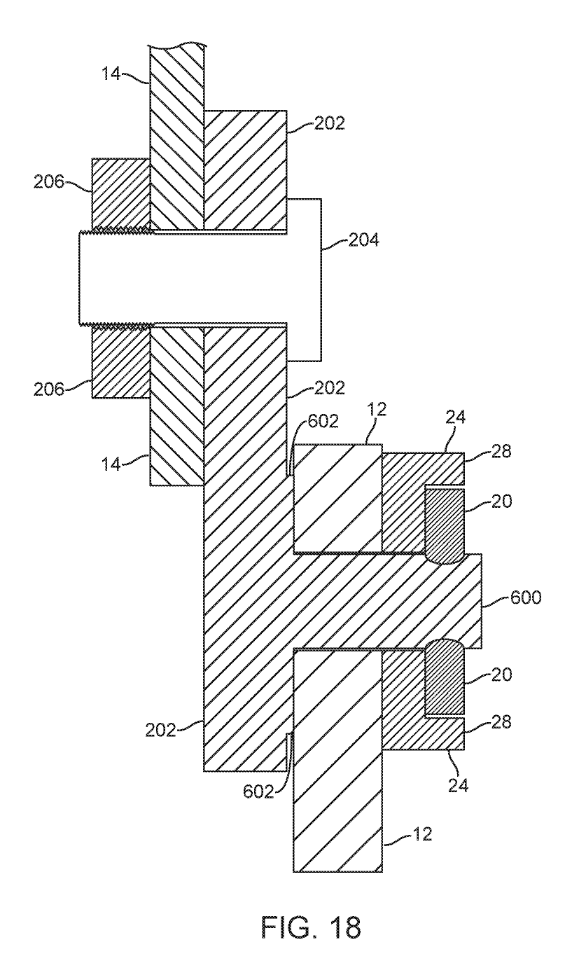

FIG. 18 illustrates still another embodiment of the present invention in which the stud is integrally formed with the adapter plate either during the fabrication process or such as by welding the stud onto the adapter plate. The embodiment of FIG. 18 is otherwise similar to the other embodiments of the present invention. As particularly shown in FIG. 18, the stud portion 600 protrudes from the surface of the adapter plate 202 such that the stud portion 600 may extend through an associated aperture in the blade 12. The second, outer longitudinal end of the stud portion 600 may be in all respects similar to those of other embodiments and be provided with a transversely, centrally extending hole 17 therethrough and into which a locking pin 22 may be lodged and extend. Further, the embodiment of FIG. 18 may also include a disc-shaped flange 602 such as the flange 22 shown in FIGS. 1 and 4-6, which flange 602 is preferably integrally fashioned with the adapter plate 202 either during the fabrication process or such as by welding.

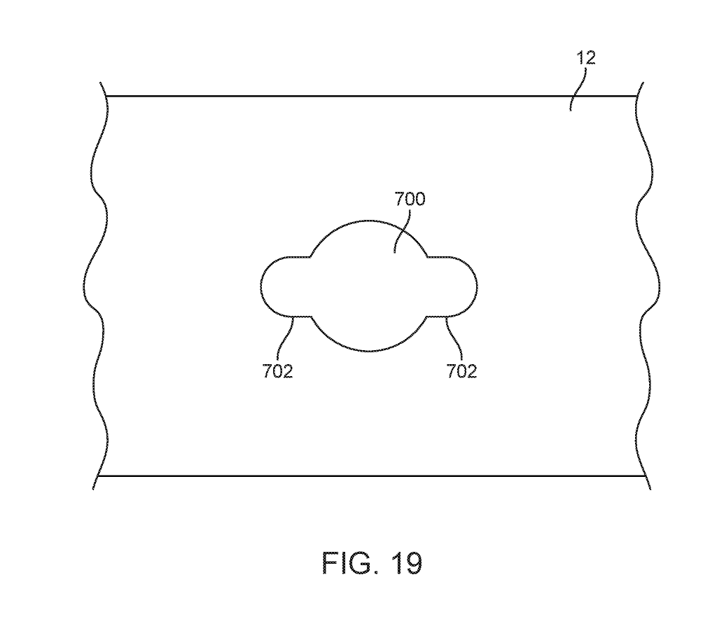

FIG. 19 illustrates the configuration of an alternative aperture that extends through the blade 12. The aperture 700 shown in FIG. 19 possesses a general cylindrical profile, but with a transversely extending slot 702 extending completely through the width of the blade 12. The slot 702 is similar to the slot 26 in the taper lock ring 24 and functions in a similar manner. The slot 702 is sized so as to permit the locking pin 26 to slide in and completely through the slot 702, Thus, after the taper lock ring 24 has been removed from the stud 16, by selecting a particular orientation of the locking pin 26, the blade 12 may be pulled away from the moldboard 14 or the adapter plate 202 such that the stud 16 and the locking pin 26 stay in place. A replacement blade 12 with such an alternative aperture may then be placed against the moldboard 14 or the adapter plate 202 in a reverse process. It will be appreciated that, by employing such an alternative aperture, in order to replace a blade 12, the only things that need to be removed are the taper locking ring 24 and the blade 12 itself, and in order to mount a new blade 12 to either the moldboard 14 or the adapter plate 202, the only things that need to be replaced are the taper locking ring 24 and the new blade 12, Naturally, if the cap 500 were employed, then the cap 500 would need to be removed and replaced as well.

While exemplary embodiments have been presented in the foregoing description of the invention, it should be appreciated that a vast number of variations within the scope of the invention may exist. The foregoing examples are not intended to limit the nature or the scope of the invention in any way. Rather, the foregoing detailed description provides those skilled in the art with a foundation for implementing other exemplary embodiments of the invention.

We claim:

1. A snow plow moldboard and blade assembly including:
(a) a moldboard possessing a laterally extending lower edge, said moldboard possessing a thickness along the lower edge thereof, possessing a front surface and a rear surface, and possessing a series of laterally spaced apertures extending through the thickness of the lower edge thereof, each moldboard aperture defined by a wall;
(b) a blade depending from the lower edge of said moldboard, said blade possessing a length, a height, and a thickness and possessing a front face and a rear face, the length of said blade laterally extending along the lower edge of said moldboard, said blade possessing a series of laterally spaced apertures extending through the thickness of said blade, each blade aperture defined by a wall, the apertures in the series of apertures in said blade being positioned so as to overlap and be coextensive with associated ones of the apertures in the series of apertures in said moldboard;
(c) means extending through at least one set of overlapping, coextensive apertures in said blade and said moldboard for selectively mounting said blade to said moldboard.

2. The snow plow moldboard and blade assembly according to claim 1 wherein said mounting means comprises a connector assembly including:
an elongate stud possessing a longitudinal length and two opposing longitudinal ends, a first longitudinal end possessing a threaded periphery adapted to receive a nut threadably thereon, a second longitudinal end possessing a transverse hole therein, said stud extending through at least one of the set of overlapping apertures in said blade and said moldboard such that the first longitudinal end thereof extends behind the rear surface of said moldboard and the second longitudinal end thereof extends in front of the front face of said blade;
a nut threadably mounted about the threaded periphery on the first longitudinal end of said stud;
a locking pin extending into the transverse hole in the second longitudinal end of said stud; and
a taper lock ring circumferentially mounted about said stud between said locking pin and the front face of said blade.

3. The snow plow moldboard and blade assembly according to claim 1 wherein at least one aperture in said moldboard is threaded and wherein said mounting means comprises a connector assembly including:
an elongate stud possessing a longitudinal length and two opposing longitudinal ends, a first longitudinal end possessing a threaded periphery adapted to be threadably received in the at least one threaded aperture and a second longitudinal end possessing a transverse hole therein, said stud extending through the at least one of the set of overlapping apertures in said blade and said moldboard, wherein one of the set of overlapping apertures includes the at least one threaded aperture, such that the second longitudinal end thereof extends in front of the front face of said blade;
a locking pin extending into the transverse hole in the second longitudinal end of said stud; and
a taper lock ring circumferentially mounted about said stud between said locking pin and the front face of said blade.

4. The snow plow moldboard and blade assembly according to claim 2 wherein said stud possesses an integrally formed flange radially protruding therefrom and disposed between said moldboard and said blade.

5. The snow plow moldboard and blade assembly according to claim 4 wherein the flange possesses the configuration of a disc having two opposing planar, radially extending, parallel surfaces, with one of the parallel surfaces abutting the front surface of said moldboard and the other of the parallel surfaces abutting the rear face of said blade.

6. The snow plow moldboard and blade assembly according to claim 2 wherein a spacer ring is disposed circumferentially about said stud between the front surface of said moldboard and the rear face of said blade.

7. The snow plow moldboard and blade assembly according to claim 3 wherein said stud possesses an integrally formed flange radially protruding therefrom and disposed between said moldboard and said blade.

8. The snow plow moldboard and blade assembly according to claim 7 wherein the flange possesses the configuration of a disc having two opposing planar, radially extending, parallel surfaces, with one of the parallel surfaces abutting the front surface of said moldboard and the other of the parallel surfaces abutting the rear face of said blade.

9. The snow plow moldboard and blade assembly according to claim 3 wherein a spacer ring is disposed circumferentially about said stud between the front surface of said moldboard and the rear face of said blade.

10. The snow plow moldboard and blade assembly according to claim 2 wherein said taper lock ring possesses an inner surface and an outer surface, wherein the inner surface faces the front face of said blade and wherein the outer surface possesses a helical incline.

11. The snow plow moldboard and blade assembly according to claim 10 wherein the inner surface abuts the front face of said blade and the outer surface abuts said pin.

12. The snow plow moldboard and blade assembly according to claim 2 wherein said taper lock ring possesses a longitudinally outwardly protruding lip circumferentially surrounding said pin.

13. The snow plow moldboard and blade assembly according to claim 2 wherein said taper locldng ring possesses a slot therein transversely extending partially therethrough and completely longitudinally therethrough, the slot configured to permit said pin to slide in and completely through the slot.

14. The snow plow moldboard and blade assembly according to claim 2 wherein the pin is compressively wedged into the transverse hole in the stud.

15. The snow plow moldboard and blade assembly according to claim 2 further including an end cap completely covering said pin and the second longitudinal end of said stud and covering at least a portion of said taper lock ring.

16. A snow plow moldboard, adapter plate, and blade assembly including:
(a) a moldboard possessing a laterally extending lower edge, said moldboard possessing a thickness along the lower edge thereof, possessing a front surface and a rear surface, and possessing a series of laterally spaced apertures extending through the thickness of the lower edge thereof, each moldboard aperture defined by a wall;
(b) an adapter plate disposed along the lower edge of said moldboard, said adapter plate possessing a thickness, said adapter plate possessing a forward surface and a rearward surface, and possessing a series of laterally spaced upper apertures extending through the thickness of said adapter plate and a series of laterally spaced lower apertures extending through the thickness of said adapter plate, each of the upper apertures and each of the lower apertures defined by a wall, the apertures in the series of upper apertures in said adapter plate being positioned so as to overlap and be coextensive with associated ones of the apertures in the series of apertures in said moldboard;
(c) means extending through at least one of the overlapping, coextensive upper apertures in said adapter plate and the apertures in said moldboard for securing said adapter plate to said moldboard;
(d) a blade depending from the lower edge of said adapter plate, said blade possessing a length, a height, and a thickness and possessing a front face and a rear face, the length of said blade laterally extending along the lower edge of said adapter plate, said blade possessing a series of laterally spaced apertures extending through the thickness of said blade, each blade aperture defined by a wall, the apertures in the series of apertures in said blade being positioned so as to overlap and be coextensive with associated ones of the apertures in the series of lower apertures in said adapter plate;
(e) means extending through at least one set of overlapping, coextensive apertures in said blade and said adapter plate for selectively mounting said blade to said adapter plate.

17. The snow plow moldboard, adapter plate, and blade assembly according to claim 16 wherein said mounting means comprises a connector assembly including:
an elongate stud possessing a longitudinal length and two opposing longitudinal ends, a first longitudinal end possessing a threaded periphery adapted to receive a nut threadably thereon, a second longitudinal end possessing a transverse hole therein, said stud extending through at least one of the set of overlapping apertures in said blade and said adapter plate such that the first longitudinal end thereof extends behind the rearward surface of said adapter plate and the second longitudinal end thereof extends in front of the front face of said blade;
a nut threadably mounted about the threaded periphery on the first longitudinal end of said stud;
a locking pin extending into the transverse hole in the second longitudinal end of said stud; and
a taper lock ring circumferentially mounted about said stud between said locking pin and the front face of said blade.

18. The snow plow moldboard, adapter plate, and blade assembly according to claim 16 wherein at least one aperture in said adapter plate is threaded and wherein said mounting means comprises a connector assembly including:
an elongate stud possessing a longitudinal length and two opposing longitudinal ends, a first longitudinal end possessing a threaded periphery adapted to be threadably received in the at least one threaded aperture, a second longitudinal end possessing a transverse hole therein, said stud extending through at least one of the set of overlapping apertures in said blade and said adapter plate, wherein one of the set of overlapping apertures includes the at least one threaded aperture, such that the second longitudinal end thereof extends in front of the front face of said blade;
a locking pin extending into the transverse hole in the second longitudinal end of said stud; and
a taper lock ring circumferentially mounted about said stud between said locking pin and the front face of said blade.

19. The snow plow moldboard, adapter plate, and blade assembly according to claim 17 wherein said stud possesses an integrally formed, conically shaped flange radially protruding therefrom, wherein the forward surface of said adapter plate possesses a depression in the periphery of each aperture in the series of lower apertures, said depression possessing a configuration conforming to the flange, and, wherein the flange is conformingly disposed in the depression in the forward surface of said adapter plate.

20. The snow plow moldboard, adapter plate, and blade assembly according to claim 17 wherein said taper lock ring possesses an inner surface and an outer surface, wherein the inner surface faces the front face of said blade, wherein the outer surface faces said locking pin, and wherein the outer surface possesses a helical incline.

21. The snow plow moldboard, adapter plate, and blade assembly according to claim 20 wherein the inner surface abuts the front face of said blade and the outer surface abuts said locking pin.

22. The snow plow moldboard, adapter plate, and blade assembly according to claim 17 wherein said taper lock ring possesses a longitudinally outwardly protruding lip circumferentially surrounding said locking pin.

23. The snow plow moldboard, adapter plate, and blade assembly according to claim 17 wherein said taper locking ring possesses a slot therein extending partially transversely therethrough and completely longitudinally therethrough, the slot configured to permit said locking pin to slide in and completely through the slot.

24. The snow plow moldboard, adapter plate, and blade assembly according to claim 17 wherein the locking pin is compressively wedged into the transverse hole in said stud.

25. The snow plow moldboard, adapter plate, and blade assembly according to claim 17 further including an end cap completely covering said pin and the second longitudinal end of said stud and covering at least a portion of said taper lock ring.

26. A connector mounting a snow plow blade to a supporting structure, the connector including:
a stud possessing a first longitudinal end and a second, opposing longitudinal end, said stud extending through a blade hole in said blade and through a structure hole in said structure, such that the second longitudinal end extends beyond said blade; and
means mounted on said stud for selectively maintaining said stud in a position of extension through the blade hole and through the structure hole with the second longitudinal end extending beyond said blade and for selectively securing said blade to said structure.

27. The connector according to claim 25 wherein said means includes a taper lock ring mounted on the second longitudinal end of said stud.

28. The connector according to claim 26 wherein said means includes a pin mounted on the second longitudinal end of said stud and abutting said taper lock ring.

29. The connector according to claim 25 wherein said means compressively secures said blade to said structure.

30. A snow plow moldboard, adapter plate, and blade assembly including:
(a) a moldboard possessing a laterally extending lower edge;
(b) an adapter plate disposed along the lower edge of said moldboard;
(c) a blade depending from the lower edge of said adapter plate, said blade possessing a length and a thickness and possessing a front face and a rear face, the length of said blade laterally extending along the lower edge of said adapter plate, said blade possessing a series of laterally spaced apertures extending through the thickness of said blade, each blade aperture defined by a wall;
(d) means extending through at least one of the apertures in said blade for selectively mounting said blade to said adapter plate.

31. The snow plow moldboard, adapter plate, and blade assembly according to claim 29 wherein said mounting means comprises a connector assembly including:
an elongate stud extending from said adapter plate and possessing a longitudinal length and two opposing, first and second longitudinal ends, a second longitudinal end possessing a locking pin mounted thereon, said stud extending through at least one of the apertures in said blade such that the second longitudinal end thereof extends in front of the front face of said blade;
a taper lock ring circumferentially mounted about said stud between said locking pin and the front face of said blade.

32. The snow plow moldboard, adapter plate, and blade assembly according to claim 31 wherein said adapter plate and said stud are integrally formed.

33. The snow plow moldboard, adapter plate, and blade assembly according to claim 31 wherein said adapter plate and said stud are discrete, separate components of said assembly.

34. The snow plow moldboard, adapter plate, and blade assembly according to claim 31 wherein said stud and said locking pin are integrally formed.

35. The snow plow moldboard, adapter plate, and blade assembly according to claim 31 wherein said stud and said locking pin are discrete, separate components of said assembly.

36. The snow plow moldboard, adapter plate, and blade assembly according to claim 30 wherein said stud possesses an integrally formed, conically shaped flange radially protruding therefrom in a region immediately adjacent to said adapter plate.

37. The snow plow moldboard, adapter plate, and blade assembly according to claim 30 wherein said taper lock ring possesses an inner surface and an outer surface, wherein the inner surface faces the front face of said blade, wherein the outer surface faces said locking pin, and wherein the outer surface possesses a helical incline.

38. The snow plow moldboard, adapter plate, and blade assembly according to claim 37 wherein the inner surface abuts the front face of said blade and the outer surface abuts said locking pin.

39. The snow plow moldboard, adapter plate, and blade assembly according to claim 31 wherein said taper lock ring possesses a longitudinally outwardly protruding lip circumferentially surrounding said locking pin.

40. The snow plow moldboard, adapter plate, and blade assembly according to claim 31 wherein said taper locking ring possesses a slot therein extending partially transversely therethrough and completely longitudinally therethrough, the slot configured to permit said locking pin to slide in and completely through the slot.

41. The snow plow moldboard, adapter plate, and blade assembly according to claim 31 wherein said locking pin is compressively wedged into a transverse hole in the second longitudinal end of said stud.

42. The snow plow moldboard, adapter plate, and blade assembly according to claim 31 further including an end cap completely covering said pin and the second longitudinal end of said stud and covering at least a portion of said taper lock ring.

43. The snow plow moldboard, adapter plate, and blade assembly according to claim 31 wherein at least one blade aperture wall includes a slot configuration extending partially transversely therethrough and completely through the thickness thereof, the wall slot configured to permit said locking pin to slide in and completely through the wall slot.

44. A connector mounting a snow plow blade to a supporting structure, the connector including:
a stud extending from said supporting structure and possessing a distal end, said stud extending through a blade hole in said blade, such that the distal end extends beyond said blade; and
means mounted on said stud for selectively maintaining said stud in a position of extension through the blade hole with the distal end extending beyond said blade and for selectively securing said blade to said structure.

45. The connector according to claim 44 wherein said means includes a taper lock ring mounted on the distal end of said stud.

46. The connector according to claim 44 wherein said means includes a locking pin mounted on the distal end of said stud and abutting said taper lock ring.

47. The connector according to claim 44 wherein said means compressively secures said blade to said structure.
